(19) United States
(12) Patent Application Publication
(10) Pub. No.: US 2016/0005046 A1
(43) Pub. Date: Jan. 7, 2016

(54) APPARATUS AND METHOD FOR DISPLAYING AMOUNT OF MONEY

(71) Applicant: Wistron Corporation, New Taipei City (TW)

(72) Inventors: Yu-Ru Li, New Taipei City (TW); Chia-Hui Chang, New Taipei City (TW); Ming-Tso Chen, New Taipei City (TW)

(21) Appl. No.: 14/542,789

(22) Filed: Nov. 17, 2014

(30) Foreign Application Priority Data
Jul. 2, 2014 (TW) 103122819

(51) Int. Cl. G06Q 20/42; G07B 15/06

(52) U.S. Cl. CPC G06Q 20/42; G07B 15/063

(57) ABSTRACT

An apparatus and a method for displaying amount of money are disclosed. The apparatus for displaying amount of money comprises a signal detection module, a position module, a storage device, a micro controller and a monitor. The signal detection module detects a radio frequency identification (RFID) signal outputted from a toll gantry. The position module provides a position information. The storage device stores a gantry information. After the RFID signal was detected, the micro controller calculates an original debit amount according to the position information and the gantry information, and generates a money information according to the original debit amount. The monitor shows the money information.

This application claims the benefit of Taiwan application Serial No. 103122819, filed Jul. 2, 2014, the subject matter of which is incorporated herein by reference.

### BACKGROUND OF THE DISCLOSURE

1. Field of the disclosure

The invention is related in general to a display device, and more particularly to an apparatus and a method for displaying amount of money.

2. Description of the Related Art

To increase the traffic flow in motor way, conventional manual toll collection has been replaced with an electronic toll collection (ETC) system. The driver disposes an electronic tag (eTag) on his/her vehicle. When the vehicle passes through a toll gantry, the radio frequency identification (RFID) signal outputted from a toll gantry will activate the eTag within the sensing area to complete the debit operation of the ETC system.

However, current eTag is incapable of showing the balance after the debit operation immediately In order to check the balance of the eTag, the user has to use a network or visit an ETC outlet or one of the contracted convenient shops. If the overdraft reaches a predetermined amount of money, the user has to pay an extra processing charge on top of the deficit.

### SUMMARY OF THE DISCLOSURE

The invention is related to an apparatus and a method for displaying amount of money.

According to one embodiment of the present invention, an apparatus for displaying amount of money is disclosed. The apparatus for displaying amount of money comprises a signal detection module, a position module, a storage device, a micro controller and a monitor. The signal detection module detects a radio frequency identification (RFID) signal outputted from a toll gantry. The position module provides a position information. The storage device stores gantry information. After the RFID signal was detected, the micro controller calculates an original debit amount according to the position information and the gantry information, and generates a money information according to the original debit amount. And the monitor shows the money information.

According to another embodiment of the present invention, a method for displaying amount of money is disclosed. The method for displaying amount of money comprises following steps. Whether a radio frequency identification (RFID) signal outputted from a toll gantry is detected is determined. After the RFID signal was detected, an original debit amount is calculated according to the position information and the gantry information. A money information is generated according to the original debit amount. The money information is shown.

The above and other aspects of the disclosure will become better understood with regard to the following detailed description of the preferred but non-limiting embodiment (s). The following description is made with reference to the accompanying drawings.

### BRIEF DESCRIPTION OF THE DRAWINGS

FIG. 1 is a block diagram of an apparatus for displaying amount of money.

FIG. 2 is a schematic diagram of an apparatus for displaying amount of money and a toll gantry.

FIG. 3 is a flowchart of a method for displaying amount of money.

### DETAILED DESCRIPTION OF THE DISCLOSURE

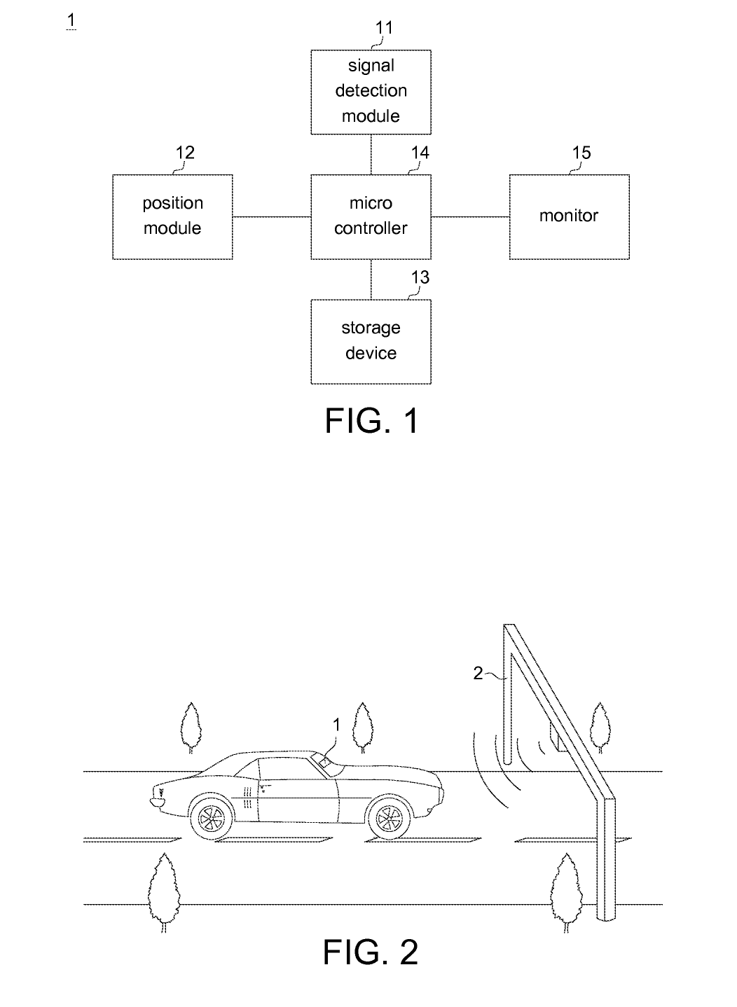

Refer to FIG. 1 and FIG. 2. FIG. 1 is a block diagram of an apparatus for displaying amount of money. FIG. 2 is a schematic diagram of an apparatus for displaying amount of money and a toll gantry. The apparatus for displaying amount of money 1 is used in an electronic toll collection (ETC) system, and comprises a signal detection module 11, a position module 12, a storage device 13, a micro controller 14 and a monitor 15. The signal detection module 11 detects a radio frequency identification (RFID) signal outputted from a toll gantry 2. The position module 12 can be realized by such as a global positioning system (GPS). The position module 12 provides a position information, which comprises vehicle location. The storage device 13 can be an electrically erasable programmable read-only memory (EEPROM) as example, and stores a gantry information. The gantry information comprises a gantry position and a gantry deduction list. The gantry position can be the latitude and longitude of a toll gantry 2 as example. After the RFID signal was detected by the signal detection module 11, the micro controller 14 calculates an original debit amount according to the position information and the gantry information, and generates a money information according to the original debit amount. The money information can be an original debit amount or a balance of an electronic tag (eTag) as example. The monitor 15, such as an electronic ink (E-Ink) display, shows the money information.

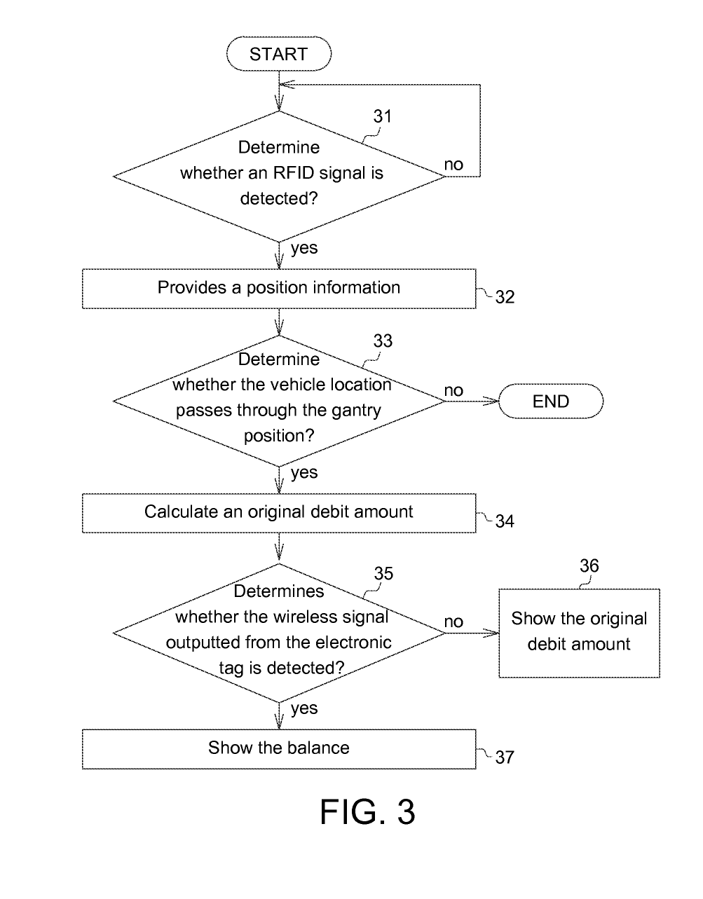

Refer to FIG. 1, FIG. 2 and FIG. 3. FIG. 3 a flowchart of a method for displaying amount of money. Firstly, the method begins as step 31 said, whether an RFID signal is detected by the signal detection module 11 or not. If there is no any RFID signal being detected by module 11, then step 31 is repeated. Conversely, if the signal detection module 11 detects the RFID signal, the method proceeds to step 32. In step 32, the position module 12 provides a position information to the micro controller 14. Then, the method proceeds to step 33, whether the vehicle location passes through the gantry of the toll gantry 2 is determined by the micro controller 14 according to the gantry position of the position information. If the vehicle location does not pass through the gantry of the toll gantry 2, the method for displaying amount of money terminates. Conversely, if the vehicle location passes through the gantry position of the toll gantry 2, the method proceeds to step 34.

In step 34, an original debit amount is calculated by the micro controller 14 according to a gantry deduction list of the gantry information. The gantry deduction list comprises amount of money user should pay for passing through different toll gantries. The micro controller 14 determines whether the signal detection module 11 detects a wireless signal outputted from the electronic tag. It is to be understood that if the user is an eTag user, the eTag will respond to the RFID signal and emit a wireless signal as the vehicle gets close to the toll gantry 2. Conversely, if the user is not an eTag user, the eTag will not respond to the RFID signal and will not emit a wireless signal as the vehicle gets close to the toll gantry 2.

If the signal detection module 11 does not detect the wireless signal, the method proceeds to step 36. In step 36, the original debit amount is used as a money information by the micro controller 14, and the original debit amount is shown on the monitor 15. Conversely, if the signal detection module 11 detects the wireless signal, the method proceeds to step 37. In step 37, a balance of the eTag is calculated by the micro controller 14 according to the original debit amount, used as the money information, and shown on the monitor 15.

Furthermore, if the user is an eTag user, the micro controller 14 first of all calculates the preferential debit amount according to the original debit amount and preferential terms, and then calculates the balance as the money information according to the preferential debit amount. The preferential debit amount is less than the original debit amount. In general, since the stored value of the eTag is prepaid by the user, the eTag user is provided with some preferential terms. For example, the eTag user can have a 10% discount of the debit amount.

The apparatus and the method for displaying amount of money disclosed in above embodiments of the invention which can be used in an

ETC system and help to resolve a disadvantage of a conventional eTag which is incapable of showing the balance. Besides, those who are not eTag users can know the original debit amount immediately by using the apparatus and the method for displaying amount of money.

While the invention has been described by way of example and in terms of the embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. An apparatus for displaying amount of money, comprising:
a signal detection module for detecting a radio frequency identification (RFID) signal outputted from a toll gantry;
a position module for providing a position information;
a storage device for storing a gantry information; and
a micro controller for calculating an original debit amount according to the position information and the gantry information after the RFID signal was detected, and generating a money information according to the original debit amount; and
a monitor for showing the money information.

2. The apparatus for displaying amount of money according to claim 1, wherein the micro controller further determines whether the signal detection module detects a wireless signal outputted from an electronic tag (eTag): if the signal detection module does not detect the wireless signal, the micro controller uses the original debit amount as the money information.

3. The apparatus for displaying amount of money according to claim 1, wherein the micro controller further determines whether the wireless signal detection module detects a wireless signal outputted from an eTag: if the signal detection module detects the wireless signal, the micro controller calculates a balance of the eTag according to the original debit amount and uses the balance as the money information.

4. The apparatus for displaying amount of money according to claim 3, wherein the micro controller calculates a preferential debit amount according to the original debit amount and a preferential terms, and calculates the balance according to the preferential debit amount and use the balance as the money information, and the preferential debit amount is less than the original debit amount.

5. The apparatus for displaying amount of money according to claim 1, wherein the position information comprises a vehicle location, the gantry information comprises a gantry position and a gantry deduction list, and the micro controller determines whether the vehicle location passes through the gantry position according to the gantry position: if the vehicle location passes through the gantry position, the micro controller calculates the original debit amount according to the gantry deduction list.

6. A method for displaying amount of money, comprising:
determining whether a radio frequency identification (RFID) outputted from a toll gantry signal is detected;
calculating an original debit amount according to a position information and a gantry information after the RFID signal was detected;
generating a money information according to the original debit amount; and
showing the money information.

7. The method for displaying amount of money according to claim 6, further comprising:
determining whether a wireless signal outputted from an eTag is detected; and
using the original debit amount as the money information if the wireless signal is not detected.

8. The method for displaying amount of money according to claim 6, further comprising:
determining whether a wireless signal outputted from an eTag is detected; and
calculating a balance of the eTag as the money information according to the original debit amount if the wireless signal is detected.

9. The method for displaying amount of money according to claim 8, wherein the calculation step of the balance comprises:
calculating a preferential debit amount according to the original debit amount and a preferential terms; and
calculating and using the balance as the money information according to the preferential debit amount, wherein the preferential debit amount is less than the original debit amount.

10. The method for displaying amount of money according to claim 6, wherein the position information comprises a vehicle location, the gantry information comprises a gantry position and a gantry deduction list, and the micro controller determines whether the vehicle location passes through the gantry position according to the gantry position: if the vehicle location passes through the gantry position, the micro controller calculates an original debit amount according to the gantry deduction list.
